(19) United States
(12) Patent Application Publication
(10) Pub. No.: US 2026/0340496 A1
(43) Pub. Date: Oct. 29, 2026

(54) METHOD AND SYSTEM FOR AUTOMATICALLY INTEGRATING AN EXTERNAL MACHINE LEARNING MODEL INTO A TARGET COMPUTING ENVIRONMENT

(71) Applicant: LTI Mindtree Ltd, Mumbai (IN)

(72) Inventor: Kakumanu Sudhir Kumar, Mumbai (IN)

(21) Appl. No.: 19/361,057

(22) Filed: Oct. 17, 2025

(30) Foreign Application Priority Data
Apr. 25, 2025 (IN) 202521039722

(51) Int. Cl. G06N 20/00; G06F 21/64

(52) U.S. Cl. CPC G06N 20/00; G06F 21/64

(57) ABSTRACT

A method and system for automatically integrating an external machine learning (ML) model into a target computing environment is disclosed. The system verifies the integrity of the external ML model based on model documentation using a dual-layer security verification including cryptographic validation and documentation compliance analysis. Feature requirements are extracted from the model documentation using NLP and features required by the external ML model are mapped to available data in the target computing environment using a multi-tiered mapping strategy. The system identifies missing features through comparison of model requirements and available data and generates executable code to create the identified missing features. The external ML model is then executed using the mapped and created features, and outputs from the external ML model are processed using a multi-layer approach.

### FIELD

Various embodiments of the present disclosure generally relate to integrating external machine learning models. More particularly, the disclosure relates to automatically integrating an external machine learning model into a target computing environment.

### BACKGROUND

Bring-Your-Own-Model (BYOM) is an approach that enables organizations to integrate externally developed machine learning (ML) models into their existing computing environments. Unlike traditional ML deployment methods that rely on pre-configured or vendor-specific solutions, BYOM allows enterprises to leverage third-party models or custom-built algorithms tailored to their specific needs. However, while BYOM offers significant benefits, it also introduces several technical challenges related to model compatibility, security, data integration, and deployment automation.

Organizations using BYOM solutions aim to leverage externally developed ML models within their existing computing environments. BYOM provides flexibility by allowing enterprises to integrate third-party or custom-built models without being restricted to vendor-specific platforms. However, despite its advantages, the integration process remains highly complex and requires a multi-step manual approach. Organizations must verify the integrity of the external model, ensure compatibility with available data, resolve discrepancies in feature requirements, and generate the necessary computational resources for execution.

In existing systems, integrating an external ML model into a target computing environment is a highly manual and labor-intensive process. Users must first register datasets by selecting appropriate tables or views from a database that contain all required features, including reference variables, date fields, and target variables. This step demands a thorough understanding of both the model's input requirements and the structure of the available data, increasing the likelihood of human errors and inconsistencies.

Once the dataset is registered, users must import the external ML model by uploading the necessary model files along with any associated pre-processing code. At this stage, users are responsible for manually defining, mapping, and validating features to ensure compatibility between the model's requirements and the available data. This feature mapping is particularly challenging when data sources are heterogeneous, requiring users to transform and align data formats, resolutions, or categorical representations.

After feature validation, deploying the external ML model involves writing procedural scripts, generating queries for inference execution, and verifying data outputs, all of which require significant manual intervention. Users must continuously monitor and validate the deployed model to ensure proper execution and correct results. The reliance on manual steps throughout the integration process not only increases the risk of configuration errors but also extends deployment timelines, making it difficult to scale BYOM solutions efficiently in enterprise environments.

The existing manual approach to integrating external ML models requires users to perform a series of expert-dependent tasks, including dataset registration, file uploads, manual feature mapping, and procedural configuration. Each of these steps involves intricate verification and mapping processes that demand domain expertise and careful attention to detail. Given the complexity of modern ML models, even minor misconfigurations can lead to significant performance degradation or outright failure of the integration.

One of the primary limitations of this manual workflow is its inability to dynamically adapt to evolving feature sets or changes in model configurations. As ML models and analytics frameworks become increasingly sophisticated, they often introduce new feature requirements, updated processing techniques, or changes in input-output relationships. The rigid nature of existing solutions makes it challenging to accommodate such variations without requiring users to manually reconfigure datasets, redefine mappings, and update deployment procedures. This lack of adaptability is particularly problematic when dealing with diverse ML algorithms that operate on different data modalities, necessitate distinct preprocessing steps, or have varying dependencies on structured and unstructured data sources.

Furthermore, as model complexity grows, the manual integration process becomes increasingly burdensome, leading to inefficiencies in deployment timelines and increased risk of human errors. Organizations that rely on BYOM solutions at scale often struggle with maintaining consistency across multiple integrations, as each new model requires a fresh round of labor-intensive setup. The cumulative effect of these inefficiencies not only hampers productivity but also limits the ability of enterprises to rapidly experiment with and deploy cutting-edge machine learning innovations.

Several well-established solutions exist for integrating machine learning models into enterprise environments. However, most of these solutions rely on manual processes that are inherently slow, error-prone, and require extensive user intervention. Traditional model integration workflows demand expert involvement at every stage, from dataset registration and feature mapping to model validation and deployment. These known solutions, while functional, lack automation, making them unsuitable for organizations looking to scale BYOM adoption efficiently.

In response to the inefficiencies of purely manual approaches, some platforms have introduced low-code or no-code solutions for model registration and feature mapping. These platforms reduce the technical burden by enabling users to configure model inputs and outputs through visual interfaces or guided workflows. However, these existing systems still rely on manual feature mapping and validation, often requiring users to inspect, adjust, and troubleshoot model configurations themselves. More importantly, they do not incorporate advanced mechanisms for security verification, dynamic feature synthesis, or automated postprocessing, leaving gaps in reliability and adaptability.

Currently, no known solution integrates a secure checksum-based validation mechanism alongside LLM-powered compliance checking, automated feature synthesis, and a multi-layer hybrid output postprocessing framework into a single, end-to-end workflow. While certain individual components, such as LLM-assisted code generation, have been explored in isolated contexts, no existing system offers a fully automated BYOM lifecycle that accommodates any ML model type with the level of security, adaptability, and automation.

Therefore, in order to address the aforementioned challenges, there is a need for a technical solution that highlights the gap in existing technologies, underscoring the need for an efficient approach that seamlessly integrates security, data validation, dynamic feature synthesis, and automated execution in an enterprise-ready BYOM framework.

### SUMMARY

A method and system for automatically integrating an external ML model into a target computing environment is disclosed. The system verifies the integrity of an external ML model based on associated with model documentation, using a dual-layer security verification including cryptographic validation and documentation compliance analysis. The cryptographic validation includes extraction of an expected checksum from the model documentation, and comparison of the expected checksum with a calculated checksum of the external machine learning model. The documentation compliance analysis detects malicious content and quality issues using a language learning model.

Feature requirements are extracted from the model documentation using natural language processing and features required by the external machine learning model are mapped to available data in the target computing environment using a multi-tiered mapping strategy. The system identifies missing features through comparison of model requirements and available data and generates executable code to create the identified missing features. The external machine learning model is then executed using the mapped and created features, and process outputs from the external machine learning model using a multi-layer approach.

### BRIEF DESCRIPTION OF THE FIGURES

FIG. 1 is a diagram that illustrates an exemplary environment within which various embodiments of the present disclosure may function.

FIG. 2 is a diagram that illustrates a system for integrating an external ML model into a target computing environment, in accordance with an embodiment of the disclosure.

FIG. 3 is an exemplary diagram that illustrates the integration of an externally developed ML model into the target environment, in accordance with an embodiment of the disclosure.

FIG. 4 is a diagram that illustrates a flowchart for a method for integrating an external ML model into the target computing environment, in accordance with an embodiment of the present disclosure.

### DETAILED DESCRIPTION

Pursuant to various embodiments, the present disclosure relates to a method and system for automatically integrating an external ML model into a target computing environment. The system verifies the integrity of an external ML model based on associated model documentation, using a dual-layer security verification including cryptographic validation and documentation compliance analysis. The cryptographic validation includes extraction of an expected checksum from the model documentation, and comparison of the expected checksum with a calculated checksum of the external machine learning model. The documentation compliance analysis detects malicious content and quality issues using a language learning model.

Feature requirements are extracted from the model documentation using natural language processing and features required by the external ML model are mapped to available data in the target computing environment using a multi-tiered mapping strategy. The system identifies missing features through comparison of model requirements and available data and generates executable code to create the identified missing features. The external ML model is then executed using the mapped and created features, and process outputs from the external ML model using a multi-layer approach.

In one or more embodiments, the external ML model refers to a pre-trained or custom-developed machine learning model that is not natively built within the target computing environment but is instead sourced from an external repository, third-party provider, or another computing system.

In some non-limiting embodiments, the external ML model may include various types of machine learning architectures, such as supervised learning models, unsupervised learning models, reinforcement learning models, deep learning frameworks, or ensemble-based models. The ML models can be in different formats, including serialized model files (e.g., TensorFlow SavedModel, ONNX, PyTorch checkpoints), containerized deployments, or packaged inference APIs.

In one or more embodiments, the external ML model may also include associated metadata, preprocessing scripts, and model documentation detailing its expected inputs, feature requirements, hyperparameters, and performance characteristics. In certain embodiments, the external ML model may be trained on proprietary or publicly available datasets and require adaptation to the target computing environment's data schema, infrastructure, and execution policies.

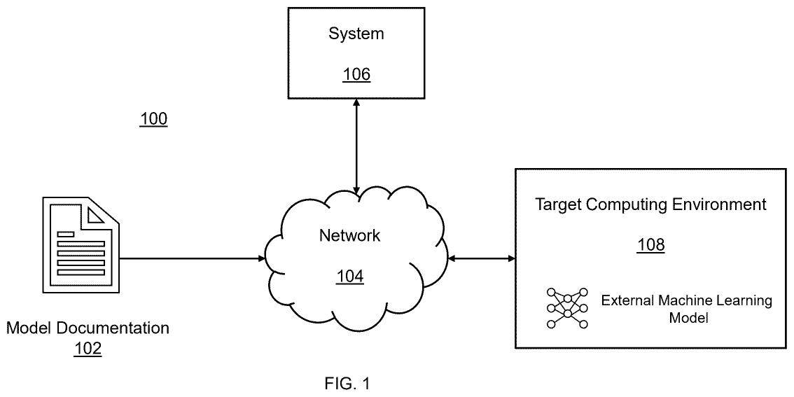

FIG. 1 is a diagram that illustrates an exemplary environment 100 within which various embodiments of the present disclosure may function. Referring to FIG. 1, the environment 100 comprises a model documentation 102, a network 104, a system 106, and a target computing environment 108.

In one or more embodiments, the model documentation 102 refers to a collection of structured and unstructured information that describes the characteristics, requirements, and usage guidelines of the external ML model. The model documentation 102 may include metadata specifying model type, input feature requirements, expected output format, preprocessing and postprocessing steps, hyperparameter configurations, and performance benchmarks. It may also contain security-related details, such as cryptographic checksums for model integrity verification and compliance guidelines to ensure adherence to regulatory or organizational policies.

In one or more embodiments, the model documentation 102 may be provided in various formats, including textual documents, JSON or YAML configuration files, API specifications, or embedded metadata within the model file itself. In some embodiments, it may also include accompanying scripts for feature transformation, training logs, or references to external repositories where additional resources are stored.

The network 104 facilitates communication between the various components of the environment 100, including the model documentation 102, and the system 106. It enables the transfer of data, instructions, and results between the different modules and the system 106, allowing for seamless identification of incremental vehicle damages. The network 104 may comprise various communication protocols, such as local area networks (LAN), wide area networks (WAN), or the internet.

The system 106 is designed to automate the entire workflow of integrating an external ML model, spanning from dataset and model registration to inference execution, regardless of the machine learning model type. The system 106 ensures secure loading and validation of external ML models while eliminating the need for manual intervention. To maintain model integrity, the system 106 implements a dual-layer verification mechanism, combining cryptographic checksum validation with an advanced documentation compliance analysis powered by a language learning model (LLM).

Additionally, the system 106 is configured to extract expected feature requirements from the model documentation 102 and enhance feature comprehension by generating comprehensive feature synonyms using LLM-based semantic analysis. To accurately align model requirements with the available data, the system 106 employs a multi-tier feature mapping strategy, where LLM serves as the final authority in resolving ambiguities and ensuring correct feature associations. Unlike conventional rule-based approaches, the system 106 dynamically generates Python code capable of inferring appropriate calculation methods from feature names without relying on predefined transformation rules.

In some non-limiting embodiment, the system 106 is configured to generate code in various programming languages beyond Python, depending on the requirements of the target computing environment 108. The system 106 dynamically determines the most suitable language for code generation based on the execution framework, data processing constraints, and integration requirements. For instance, if the target environment operates within a Java-based ecosystem, the system 106 may generate Java code to implement the necessary feature transformations. Similarly, for environments leveraging SQL-based data pipelines, the system 106 may generate optimized SQL queries to align data with model requirements. The underlying LLM-driven approach ensures that the generated code accurately infers appropriate calculation methods from feature names, independent of predefined transformation rules, thereby enabling seamless adaptability across diverse computing environments.

Furthermore, the system 106 enhances model output reliability through a multi-layer hybrid postprocessing framework. Instead of merely correcting anomalies, the LLM-powered postprocessing mechanism conducts a root cause analysis by considering input feature relationships and historical context.

In one or more embodiments, the target computing environment 108 refers to a computational infrastructure where the external machine learning model is deployed, executed, and integrated with existing data sources, workflows, and applications. The target computing environment 108 may be a cloud-based platform, an on-premises server, an edge computing device, or a hybrid architecture that combines multiple computing resources. The target computing environment 108 provides the necessary hardware, software, and data access required to support model inference and facilitate seamless interaction between the external machine learning model and enterprise systems.

In one or more embodiments, the target computing environment 108 may include data storage systems, relational or non-relational databases, data lakes, or streaming data pipelines from which required features are retrieved. It may also provide access to processing units such as CPUs, GPUs, TPUs, or dedicated AI accelerators optimized for machine learning workloads.

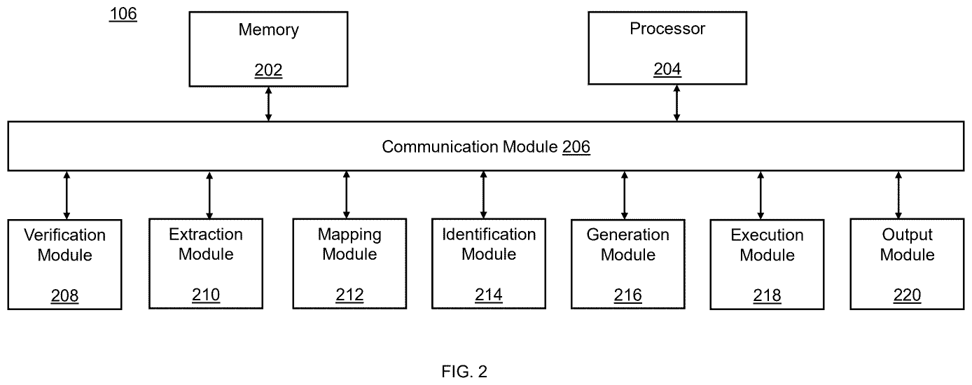

FIG. 2 is a diagram that illustrates the system 106 for integrating an external ML model into the target computing environment 108, in accordance with an embodiment of the disclosure. Referring to FIG. 2, the system 106 comprises a memory 202, a processor 204, a communication module 206, a verification module 208, an extraction module 210, a mapping module 212, an identification module 214, a generation module 216, an execution module 218, and an output module 220.

The memory 202 may comprise suitable logic, code, and/or interfaces that may be configured to store instructions (for example, computer-readable program code) that can implement various aspects of the present disclosure.

The processor 204 may comprise suitable logic, code, and/or interfaces that may be configured to execute the instructions stored in the memory 202 to implement various functionalities of the system 106 in accordance with various aspects of the present disclosure. The communication module 206 is configured to facilitate seamless interaction between the processor 204 and various modules within the system 106.

The verification module 208 may comprise suitable logic, code, and/or interfaces that may be configured to verify integrity of an external ML model based on associated model documentation 102.

In one or more embodiments, the verification module 208 employs a dual-layer security verification mechanism, combining cryptographic validation with advanced documentation compliance analysis to provide a robust and comprehensive integrity check. The cryptographic validation process ensures that the external ML model has not been tampered with by extracting an expected checksum value from the associated model documentation 102 and comparing it with a newly calculated checksum of the model file.

In one or more embodiments, the cryptographic validation process serves the critical purpose of ensuring the authenticity, integrity, and security of the external ML model before it is integrated into the target computing environment 108. By leveraging cryptographic techniques, the system 106 can detect unauthorized modifications, accidental corruption, or tampering attempts that may compromise the model's reliability and functionality. This process involves extracting an expected checksum from the model documentation 102 and comparing it with a newly computed checksum of the model file. Any mismatch between these values indicates potential discrepancies, prompting further investigation or rejection of the model.

In one or more embodiments, beyond cryptographic verification, the model documentation 102 compliance analysis enhances security by leveraging a language learning model (LLM) to perform an in-depth examination of the model documentation 102. The analysis detects potential malicious content, inconsistencies, and quality issues that may not be identifiable through traditional cryptographic methods. The LLM-powered compliance analysis evaluates factors such as missing or ambiguous feature definitions, discrepancies between stated and actual model behavior, compliance with regulatory standards, and potential risks arising from undocumented dependencies or preprocessing requirements.

In one or more embodiments, the model documentation compliance analysis serves the crucial purpose of verifying the correctness, completeness, and security of the external ML model by analyzing its associated model documentation 102. Unlike cryptographic validation, which focuses on file integrity, this analysis ensures that the ML model adheres to expected standards, does not contain malicious components, and is properly configured for integration. By leveraging the LLM, the system 106 can detect inconsistencies, missing feature definitions, ambiguous descriptions, and potential risks such as undocumented dependencies or harmful scripts.

The extraction module 210 may include suitable logic, executable code, and/or interfaces designed to automatically extract feature requirements from the model documentation 102 using advanced natural language processing (NLP) techniques. By leveraging NLP, the extraction module 210 can analyze structured and unstructured textual content within the model documentation 102, including model specifications, input schemas, data descriptions, and example datasets, to accurately determine the required feature set.

In one or more embodiments, the extraction module 210 is further configured to enhance feature identification by generating synonym dictionaries for the extracted feature requirements. This capability helps bridge terminology gaps between how features are described in the model documentation 102 and how they are named or stored in the target computing environment 108. Given that different organizations, industries, and data sources may use varied nomenclature for similar data attributes, this operation enables seamless mapping of features without requiring manual intervention.

In one or more embodiments, generating synonym dictionaries involves using a LLM to create a comprehensive list of synonyms and semantically related terms based on domain-specific terminology. The LLM analyzes contextual patterns and domain knowledge to infer potential variations in feature names, thereby improving the accuracy of feature mapping. For example, if the model documentation 102 specifies an input feature as “customer_age,” but the target database records the same information under “age_of_client” or “user_dob,” the LLM-driven synonym generation ensures that these terms are correctly linked. This dynamic synonym generation eliminates ambiguities, enhances automation, and significantly reduces the risk of feature mismatches, enabling a more robust and intelligent integration of external ML models into the target computing environment 108.

In one or more embodiments, the system 106 is further configured to dynamically generate synonym dictionaries in real time as part of the feature mapping workflow, thereby addressing and resolving domain-specific naming inconsistencies encountered during the multi-tiered mapping process. This real-time generation leverages LLMs and contextual analysis techniques to continuously interpret and learn terminology variations specific to the target computing environment 108. For example, in enterprise applications, different teams or systems might use distinct terminologies for the same data attribute, such as “employee_id,” “staff_number,” or “personnel_code.” The dynamic synonym generation component identifies such variations by analyzing both the model documentation 102 associated with the external ML model and the schema or metadata of the target environment.

The mapping module 212 may include suitable logic, code, and interfaces designed to intelligently map the feature requirements of the external ML model to the available data within the target computing environment 108. The mapping module 212 plays a vital role in automating the feature alignment process, ensuring that the necessary input variables are correctly identified and linked, thereby reducing manual effort and mitigating the risk of errors. By employing a multi-tiered mapping strategy, the system 106 can effectively handle variations in feature naming conventions, data structure differences, and contextual discrepancies between the model documentation 102 and the target computing environment 108.

In one or more embodiments, the multi-tiered mapping strategy includes four progressive levels of matching: direct matching, case-insensitive matching, synonym-based matching, and language model-assisted mapping. Direct matching is the first and most straightforward approach, wherein the system 106 checks for exact name matches between the documented feature requirements and the available data fields. If an exact match is not found, the case-insensitive matching step ensures that variations in capitalization, such as “CustomerID” versus “customerid,” do not hinder the mapping process.

Finally, language model-assisted mapping leverages a pre-trained LLM to understand contextual relationships between feature names and infer appropriate mappings even in cases where direct or synonym-based matching fails. The LLM can analyze metadata, historical mappings, and data usage patterns to determine the best feature correspondence, enabling accurate mapping even in complex and dynamic environments. This multi-tiered strategy ensures that feature alignment is robust, scalable, and adaptable to diverse ML models and data ecosystems, ultimately facilitating seamless model integration with minimal manual intervention.

In one or more embodiments, the system 106 is further configured to automatically construct a semantic data frame as part of the feature mapping and validation process. This construction begins by parsing the model documentation 102 to extract detailed textual descriptions of input features, including their semantic context, expected formats, value ranges, and usage patterns. Using NLP techniques, the system 106 interprets these descriptions and translates them into a structured data representation referred to as the semantic data frame that encapsulates not only the feature names but also their associated metadata and intended semantics.

For example, a feature described in the model documentation as “average monthly spending by customer over the last six months” would be represented in the semantic data frame with annotations indicating its temporal nature, aggregation method, and customer-centric scope. Once the semantic data frame is constructed, it serves as an intelligent intermediary between the external machine learning model's requirements and the available data fields in the target environment.

The identification module 214 may include suitable logic, code, and interfaces designed to systematically identify missing features by comparing the feature requirements of the external ML model with the available data within the target computing environment 108. The identification module 214 ensures that all required input features for model execution are present and correctly formatted, thereby preventing runtime errors and optimizing model performance.

In one or more embodiments, identifying missing features includes performing a comprehensive comparison between the model requirements extracted from the model documentation 102 and the available data attributes in the target computing environment 108. This comparison involves checking for direct feature availability, assessing structural consistency, and analyzing metadata descriptors to determine potential gaps. If a required feature is not found within the dataset, the system 106 marks it as missing and triggers corrective actions, such as feature synthesis or alternative data sourcing.

In one or more embodiments, the identification module 214 is further configured to validate features against sample payloads with data type verification. This validation step ensures that the available data not only matches the required features in terms of name and structure but also adheres to the expected data type and format specified in the model documentation 102. For example, if a ML model expects an input feature “transaction_amount” as a floating-point number, but the available dataset contains it as a string, the identification module 214 detects this inconsistency and flags it for transformation. The identification module 214 may also evaluate feature distributions to identify potential anomalies, such as missing categorical values or incorrectly formatted timestamps.

The generation module 216 may include suitable logic, code, and interfaces designed to dynamically generate executable code for creating missing features identified during the model integration process. The generation module 216 ensures that external ML models receive all necessary input features, even if those features are absent from the target computing environment's 108 dataset. By automating the generation of required features, the generation module 216 eliminates the need for manual feature engineering, reducing the risk of errors and expediting the model deployment process.

In one or more embodiments, generating executable code comprises inferring calculation methods from feature names without relying on pre-defined rules. This inference is achieved using an advanced LLM that analyzes feature names, documentation context, and historical mappings to determine the appropriate computation required to generate missing features. For example, if a model requires a feature such as “monthly_revenue,” and only “total_revenue” and “months_active” are available in the dataset, the module automatically deduces that “monthly_revenue” can be computed as “total_revenue/months_active.”

In one or more embodiments, the generation module 216 is further configured to implement fallback mechanisms when inference is unsuccessful. If the generation module 216 is unable to determine a valid transformation or computation method for a missing feature, it triggers an alternative workflow, such as querying external data sources, requesting user input for clarification, or suggesting potential feature derivations based on similar use cases. Additionally, the generation module 216 may leverage historical feature transformations applied in prior integrations to recommend appropriate computations, ensuring continuity and efficiency in recurring model deployments.

In one or more embodiments, the generation module 216 is designed to infer and implement complex time-based and lag transformations by analyzing the metadata present within the model documentation 102 associated with the external ML model. The metadata may include references to temporal variables, such as dates, time intervals, or sequential event markers, as well as domain-specific indicators suggesting chronological dependencies between features. By leveraging NLP and contextual inference techniques, the generation module 216 can identify features that require temporal manipulation such as rolling averages, window-based aggregations, or lag-based predictors and automatically generate the corresponding executable code to compute them. For instance, if the model documentation 102 indicates a dependency on “customer activity in the past 30 days” or “monthly revenue lagged by one quarter,” the generation module 216 translates such descriptions into precise programmatic transformations. Furthermore, the generation module 216 incorporates robust fallback logic to ensure successful execution across a broad spectrum of model types and target environments.

The execution module 218 may include suitable logic, code, and interfaces designed to facilitate the seamless execution of an external ML model within the target computing environment 108. Once the required features have been successfully mapped or generated, the execution module 218 ensures that the model receives the necessary input data in the correct format, allowing it to operate without manual intervention.

The output module 220 may include suitable logic, code, and interfaces that facilitate the structured processing and interpretation of outputs generated by the external ML model. Given that model outputs can vary widely in format, structure, and accuracy depending on the algorithm and the nature of the task, the output module 220 employs a multi-layer approach to ensure reliability, correctness, and contextual relevance.

In one or more embodiments, the multi-layer approach for processing outputs begins with statistical anomaly detection, where the system 106 compares the external ML model's outputs against historical statistics and predefined domain thresholds. This initial validation step helps identify any significant deviations from expected patterns, flagging potential inconsistencies or unexpected variations in predictions. By leveraging historical data distributions, the output module 220 can determine whether the generated results fall within an acceptable range, reducing the likelihood of erroneous decisions due to outlier values.

Following anomaly detection, the second layer applies domain-specific guidelines that have been extracted from the model documentation 102. Certain ML applications, such as financial forecasting, medical diagnostics, or industrial process optimization, require compliance with predefined operational rules. The output module 220 interprets these domain-specific guidelines and enforces constraints or corrective adjustments to ensure that external ML model outputs adhere to industry standards and best practices.

In some non-limiting embodiments, the domain-specific guidelines may refer to regulatory requirements, business logic constraints, operational tolerances, or industry-specific compliance standards that govern acceptable output behavior. For instance, in the context of financial forecasting, the domain-specific guidelines may include constraints such as minimum liquidity thresholds or risk exposure limits. In medical diagnostics, the guidelines may reflect clinically validated ranges or decision pathways approved by healthcare authorities. In industrial settings, the domain-specific guidelines may enforce parameters such as temperature, pressure, or production yield limits derived from safety protocols or standard operating procedures. The domain-specific guidelines, once extracted from the model documentation 102, are interpreted and applied by the output module 220 to ensure that the ML model's predictions not only align with statistical norms but also remain consistent with domain-expert expectations and real-world operational conditions.

In another embodiment, the third layer employs a LLM to conduct root cause analysis, taking into account input features and historical context. Rather than just flagging anomalies, the output module 220 leverages LLM-based reasoning to analyze why certain outputs may be incorrect, providing detailed insights into potential sources of error. This may include detecting bias in input data, uncovering inconsistencies in feature mappings, or identifying shifts in data distributions that affect model performance. By correlating input data characteristics with generated predictions, the output module 220 helps uncover deeper insights into ML model behavior and provides actionable recommendations for improvement.

In an exemplary embodiment, the deeper insights can be such as, identifying which specific input features have the highest influence on anomalous outputs, revealing temporal patterns that coincide with ML model degradation, or uncovering latent correlations between input variables that were not explicitly modeled. These insights may also include detecting previously unseen edge cases, highlighting data sparsity issues, or surfacing violations of implicit assumptions embedded in the training data or model architecture.

In an exemplary embodiment, actionable recommendations can be such as, suggesting retraining the ML model with more recent or representative data, refining feature engineering pipelines to eliminate ambiguities, adjusting domain thresholds based on newly observed trends, or enhancing data quality checks to prevent propagation of biased or incomplete input data. The system 106 may also recommend the inclusion of new input features, removal of irrelevant ones, or modification of hyperparameters to improve model robustness.

Additionally, the output module 220 is designed to provide detailed explanations for any corrections or modifications applied during output processing. If a prediction is adjusted due to anomaly detection, documentation-driven constraints, or LLM-based analysis, the system 106 generates an interpretability report outlining the specific reasoning behind the modification. This transparency ensures that end-users, including data scientists and business analysts, can understand the decision-making process, fostering trust in the automated integration workflow.

In one or more embodiments, the system 106 is configured to maintain a transparent audit trail by recording each instance of anomaly correction or output adjustment performed during the processing of the external ML model's results. This audit log captures not only the nature of the modification such as a recalibration of an output value, suppression of an outlier, or transformation of a data point but also includes an explanatory annotation automatically generated by an LLM. The LLM analyzes the context surrounding the correction, including input parameters, historical output trends, and domain-specific rules, to generate a human-readable rationale.

For example, if the external ML model predicts a customer churn probability of 98% for a customer with historically high engagement scores and recent positive interactions, the system 106 may flag the output as anomalous. If an adjustment is made such as normalizing the score to a more realistic level based on historical averages the LLM-generated note might explain that “The original churn probability significantly deviates from historical churn rates for similarly profiled users; score adjusted to reflect recent engagement behavior.”

In one or more embodiments, the system 106 further comprises an adaptive monitoring component that continuously observes model outputs within a live production environment. As operational conditions evolve such as changes in user behavior, seasonal patterns, or underlying data schema updates the system 106 dynamically detects deviations in feature relevance, output accuracy, or performance consistency. Upon identifying such shifts, the system 106 leverages the capabilities of a LLM to refine critical integration components in real time. This includes updating synonym dictionaries to reflect new or altered terminologies, enhancing the feature mapping strategy to accommodate structural changes in input data, and recalibrating postprocessing thresholds to maintain output stability. For instance, if a retail recommendation model begins underperforming after the introduction of new product categories or customer segmentation methods, the system 106 may detect performance divergence through statistical monitoring. In response, the LLM may update synonym dictionaries to include terms like “eco_smart” and “green_line” as equivalents for “sustainable_product,” and adjust output thresholds that influence promotion eligibility. This continuous self-optimization mechanism ensures that the external ML model remains well-aligned with the evolving operational context, minimizing performance degradation and reducing the need for frequent manual reconfiguration.

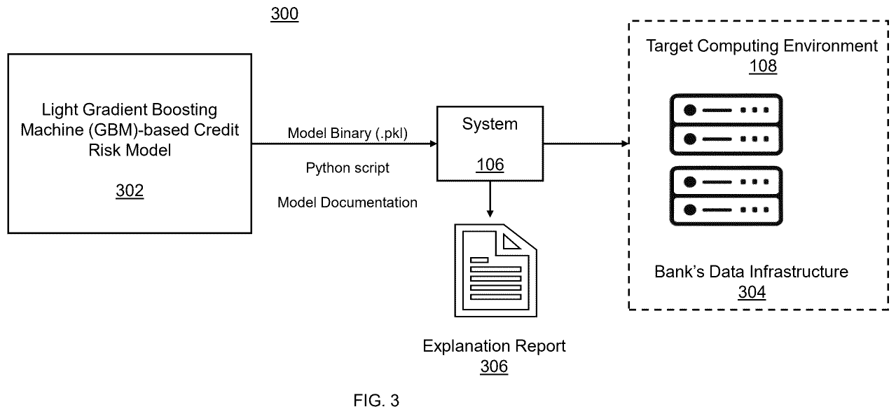

FIG. 3 is an exemplary diagram 300 that illustrates the integration of an externally developed ML model into the target environment 108, in accordance with an embodiment of the disclosure. Referring to FIG. 3, the exemplary diagram 300 comprises a Light GBM-based credit risk model 302, the system 106, the target computing environment 108 with a data infrastructure 304, and an explanatory report 306.

Consider an exemplary embodiment where a financial institution intends to integrate an externally developed Credit Risk Model 302 into its data infrastructure 304 to assess loan applicants' creditworthiness. The bank receives the externally developed Credit Risk Model 302 as a packaged file, including the model binary (.pkl), a Python preprocessing script, and associated documentation in a structured format such as a JSON schema.

Upon receiving the externally developed credit risk model 302, the verification module 208 performs a dual-layer security check to ensure integrity and compliance:
1. Cryptographic Validation:
   The system 106 extracts an expected SHA-256 checksum embedded in the externally developed Credit Risk Model's 302 documentation.
   It computes the actual checksum of the received .pkl model file and compares it with the expected checksum.
   If the checksum does not match, indicating possible corruption or tampering, the system 106 rejects the externally developed Credit Risk Model 302.
2. Documentation Compliance Analysis:
   The system 106 uses an LLM to scan the externally developed Credit Risk Model's 302 documentation for security risks.
   The LLM detects unauthorized scripts, missing regulatory compliance clauses, or potential adversarial attack vulnerabilities in the externally developed Credit Risk Model's 302 preprocessing code.
   If compliance issues are found, the system 106 flags the externally developed Credit Risk Model 302 for review before proceeding.

Once the externally developed Credit Risk Model 302 passes verification, the extraction module 210 extracts the required feature set by analyzing the externally developed Credit Risk Model's 302 documentation:
The documentation specifies the input feature names, such as income, credit_score, loan_amount, employment_status, and loan_history.
The system 106 uses NLP to generate a synonym dictionary to bridge terminology gaps (e.g., mapping loan_amount ↔loan_principal, employment_status ↔job_type).
This ensures that variations in field names do not cause mismatches in later stages.

Next, the mapping module 212 attempts to match the extracted feature requirements to available data in the bank's Redshift database using a multi-tiered strategy:
1. Direct Matching: The system 106 finds an exact match for credit_score, income, and loan_amount.
2. Case-Insensitive Matching: Employment_Status in the database is correctly mapped to employment_status.
3. Synonym-Based Matching: The synonym dictionary links loan_principal in the database to loan_amount.
4. LLM-Assisted Mapping: The system 106 identifies that loan_history can be inferred from past transactions stored in customer_transactions table, even though the exact column is missing.

The identification module 214 identifies any missing features that were not found in the previous mapping step:
The model requires loan_history, but the database does not store it directly.
The system 106 validates available data types and determines that past loan transactions in customer_transactions can be used to compute loan_history.
If the missing feature cannot be derived, the system 106 flags the issue for human intervention.

Since loan_history is missing, the generation module 216 dynamically creates a derived feature by generating Python code:
The system 106 generates a SQL query to aggregate past loan transactions per user:
   SELECT customer_id, COUNT(loan_id) AS loan_history
   FROM customer_transactions
   WHERE transaction_type=‘loan_repayment’
   GROUP BY customer_id;
This query is wrapped inside a Python function and automatically integrated into the bank's data pipeline.
If the system 106 is unable to infer a formula, it provides a fallback mechanism (e.g., flagging it for review or suggesting alternative mappings).

After successful feature extraction and transformation, the execution module 218 loads the externally developed Credit Risk Model 302 and runs inference:
The system 106 formats the input features (income, credit_score, loan_amount, employment_status, loan_history) into a structured dataframe.
The pre-processing script provided with the externally developed Credit Risk Model 302 is executed to normalize and scale input features.
The externally developed Credit Risk Model 302 is then run using the mapped and generated features.
The output consists of a credit risk score (0-1), indicating the likelihood of loan default.

The output module 220 refines the raw model outputs using a multi-layer processing approach:
1. Statistical Anomaly Detection:
   The system 106 compares predicted credit risk scores against historical distributions.
   If a customer with historically low risk suddenly receives a high-risk score, the system 106 flags the anomaly.
2. Domain-Specific Guidelines:
   The bank's documentation specifies that applicants with credit scores above 750 should not receive “high risk” classifications.
   If the externally developed Credit Risk Model 302 violates this rule, the system 106 adjusts the output or raises an alert.
3. LLM-Based Root Cause Analysis:
   The system 106 uses an LLM to analyze input features and past decisions to determine why a customer was marked as high risk.
   If the issue stems from missing or incorrect feature mappings, the system 106 provides corrective recommendations.
4. Explanatory Reporting:
   A final explanation report 306 is generated to justify each decision, helping loan officers understand why a specific score was assigned.
   The final explanation report 306 includes feature impact analysis, anomaly detection explanations, and compliance checks.

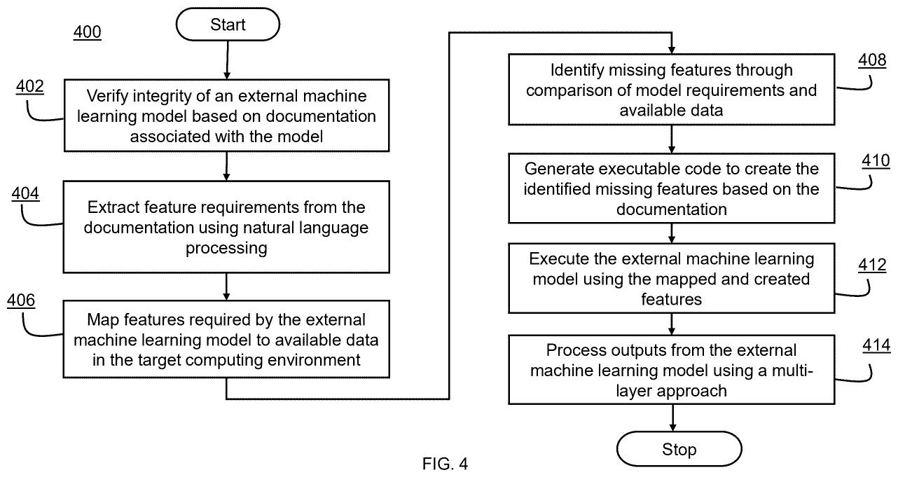

FIG. 4 is a diagram that illustrates a flowchart 400 for a method for integrating an external ML model into the target computing environment 108, in accordance with an embodiment of the present disclosure.

At 402, the verification module 208 verifies integrity of an external ML model based on associated model documentation 102.

In one or more embodiments, the verification module 208 employs a dual-layer security verification mechanism, combining cryptographic validation with advanced documentation compliance analysis to provide a robust and comprehensive integrity check. The cryptographic validation process ensures that the external ML model has not been tampered with by extracting an expected checksum value from the associated model documentation 102 and comparing it with a newly calculated checksum of the model file.

In one or more embodiments, the cryptographic validation process serves the critical purpose of ensuring the authenticity, integrity, and security of the external ML model before it is integrated into the target computing environment 108. By leveraging cryptographic techniques, the system 106 can detect unauthorized modifications, accidental corruption, or tampering attempts that may compromise the model's reliability and functionality. This process involves extracting an expected checksum from the model documentation 102 and comparing it with a newly computed checksum of the actual model file. Any mismatch between these values indicates potential discrepancies, prompting further investigation or rejection of the model.

In one or more embodiments, beyond cryptographic verification, the model documentation 102 compliance analysis enhances security by leveraging a language learning model (LLM) to perform an in-depth examination of the model documentation 102. The analysis detects potential malicious content, inconsistencies, and quality issues that may not be identifiable through traditional cryptographic methods. The LLM-powered compliance analysis evaluates factors such as missing or ambiguous feature definitions, discrepancies between stated and actual model behavior, compliance with regulatory standards, and potential risks arising from undocumented dependencies or preprocessing requirements.

In one or more embodiments, the model documentation compliance analysis serves the crucial purpose of verifying the correctness, completeness, and security of the external ML model by analyzing its associated model documentation 102. Unlike cryptographic validation, which focuses on file integrity, this analysis ensures that the ML model adheres to expected standards, does not contain malicious components, and is properly configured for integration. By leveraging the LLM, the system 106 can detect inconsistencies, missing feature definitions, ambiguous descriptions, and potential risks such as undocumented dependencies or harmful scripts.

At 404, the extraction module 210 extracts feature requirements from the model documentation 102 using NLP. By leveraging NLP, the extraction module 210 can analyze structured and unstructured textual content within the model documentation 102, including model specifications, input schemas, data descriptions, and example datasets, to accurately determine the required feature set.

In one or more embodiments, the extraction module 210 is further configured to enhance feature identification by generating synonym dictionaries for the extracted feature requirements. This capability helps bridge terminology gaps between how features are described in the model documentation 102 and how they are named or stored in the target computing environment 108. Given that different organizations, industries, and data sources may use varied nomenclature for similar data attributes, this operation enables seamless mapping of features without requiring manual intervention.

In one or more embodiments, generating synonym dictionaries involves using a LLM to create a comprehensive list of synonyms and semantically related terms based on domain-specific terminology. The LLM analyzes contextual patterns and domain knowledge to infer potential variations in feature names, thereby improving the accuracy of feature mapping.

At 406, features required by the external machine learning model are mapped using the mapping module 212 to available data in the target computing environment 108 using a multi-tiered mapping strategy. The mapping module 212 plays a vital role in automating the feature alignment process, ensuring that the necessary input variables are correctly identified and linked, thereby reducing manual effort and mitigating the risk of errors. By employing a multi-tiered mapping strategy, the system 106 can effectively handle variations in feature naming conventions, data structure differences, and contextual discrepancies between the model documentation 102 and the target computing environment 108.

In one or more embodiments, the multi-tiered mapping strategy comprises four progressive levels of matching: direct matching, case-insensitive matching, synonym-based matching, and language model-assisted mapping. Direct matching is the first and most straightforward approach, wherein the system 106 checks for exact name matches between the documented feature requirements and the available data fields. If an exact match is not found, the case-insensitive matching step ensures that variations in capitalization, such as “CustomerID” versus “customerid,” do not hinder the mapping process.

Finally, language model-assisted mapping leverages a pre-trained LLM to understand contextual relationships between feature names and infer appropriate mappings even in cases where direct or synonym-based matching fails. The LLM can analyze metadata, historical mappings, and data usage patterns to determine the best feature correspondence, enabling accurate mapping even in complex and dynamic environments. This multi-tiered strategy ensures that feature alignment is robust, scalable, and adaptable to diverse ML models and data ecosystems, ultimately facilitating seamless model integration with minimal manual intervention.

At 408, missing features are identified by the identification module 214 through comparison of model requirements and available data. The identification module 214 ensures that all required input features for model execution are present and correctly formatted, thereby preventing runtime errors and optimizing model performance.

In one or more embodiments, identifying missing features comprises performing a comprehensive comparison between the model requirements extracted from the model documentation 102 and the available data attributes in the target computing environment 108. This comparison involves checking for direct feature availability, assessing structural consistency, and analyzing metadata descriptors to determine potential gaps. If a required feature is not found within the dataset, the system 106 marks it as missing and triggers corrective actions, such as feature synthesis or alternative data sourcing.

In one or more embodiments, the identification module 214 is further configured to validate features against sample payloads with data type verification. This validation step ensures that the available data not only matches the required features in terms of name and structure but also adheres to the expected data type and format specified in the model documentation 102.

At 410, the generation module 216 generates executable code to create the identified missing features based on the model documentation 102. The generation module 216 ensures that external ML models receive all necessary input features, even if those features are absent from the target computing environment's 108 dataset. By automating the generation of required features, the generation module 216 eliminates the need for manual feature engineering, reducing the risk of errors and expediting the model deployment process.

In one or more embodiments, generating executable code comprises inferring calculation methods from feature names without relying on pre-defined rules. This inference is achieved using an advanced LLM that analyzes feature names, documentation context, and historical mappings to determine the appropriate computation required to generate missing features.

In one or more embodiments, the generation module 216 is further configured to implement fallback mechanisms when inference is unsuccessful. If the generation module 216 is unable to determine a valid transformation or computation method for a missing feature, it triggers an alternative workflow, such as querying external data sources, requesting user input for clarification, or suggesting potential feature derivations based on similar use cases. Additionally, the generation module 216 may leverage historical feature transformations applied in prior integrations to recommend appropriate computations, ensuring continuity and efficiency in recurring model deployments.

At 412, the external machine learning model is executed by the execution module 218 using the mapped and created features. Once the required features have been successfully mapped or generated, the execution module 218 ensures that the model receives the necessary input data in the correct format, allowing it to operate without manual intervention.

At 414, the output module 220 processes outputs from the external machine learning model using a multi-layer approach.

In one or more embodiments, the multi-layer approach for processing outputs begins with statistical anomaly detection, where the system 106 compares the ML model's outputs against historical statistics and predefined domain thresholds. This initial validation step helps identify any significant deviations from expected patterns, flagging potential inconsistencies or unexpected variations in predictions. By leveraging historical data distributions, the output module 220 can determine whether the generated results fall within an acceptable range, reducing the likelihood of erroneous decisions due to outlier values.

Following anomaly detection, the second layer applies domain-specific guidelines that have been extracted from the model documentation 102. Certain ML applications, such as financial forecasting, medical diagnostics, or industrial process optimization, require compliance with predefined operational rules. The output module 220 interprets these domain-specific guidelines and enforces constraints or corrective adjustments to ensure that ML model outputs adhere to industry standards and best practices.

In another embodiment, the third layer employs a LLM to conduct root cause analysis, taking into account input features and historical context. Rather than just flagging anomalies, the output module 220 leverages LLM-based reasoning to analyze why certain outputs may be incorrect, providing detailed insights into potential sources of error. This may include detecting bias in input data, uncovering inconsistencies in feature mappings, or identifying shifts in data distributions that affect model performance. By correlating input data characteristics with generated predictions, the output module 220 helps uncover deeper insights into ML model behavior and provides actionable recommendations for improvement.

Additionally, the output module 220 is designed to provide detailed explanations for any corrections or modifications applied during output processing. If a prediction is adjusted due to anomaly detection, documentation-driven constraints, or LLM-based analysis, the system 106 generates an interpretability report outlining the specific reasoning behind the modification. This transparency ensures that end-users, including data scientists and business analysts, can understand the decision-making process, fostering trust in the automated integration workflow.

Additionally, the output module 220 is designed to provide detailed explanations for any corrections or modifications applied during output processing. If a prediction is adjusted due to anomaly detection, documentation-driven constraints, or LLM-based analysis, the system 106 generates an interpretability report outlining the specific reasoning behind the modification. This transparency ensures that end-users, including data scientists and business analysts, can understand the decision-making process, fostering trust in the automated integration workflow.

In one or more embodiments, the system 106 is configured to maintain a transparent audit trail by recording each instance of anomaly correction or output adjustment performed during the processing of the external ML model's results. This audit log captures not only the nature of the modification such as a recalibration of an output value, suppression of an outlier, or transformation of a data point but also includes an explanatory annotation automatically generated by an LLM. The LLM analyzes the context surrounding the correction, including input parameters, historical output trends, and domain-specific rules, to generate a human-readable rationale.

In one or more embodiments, the system 106 further comprises an adaptive monitoring component that continuously observes model outputs within a live production environment. As operational conditions evolve such as changes in user behavior, seasonal patterns, or underlying data schema updates the system 106 dynamically detects deviations in feature relevance, output accuracy, or performance consistency. Upon identifying such shifts, the system 106 leverages the capabilities of a LLM to refine critical integration components in real time. This includes updating synonym dictionaries to reflect new or altered terminologies, enhancing the feature mapping strategy to accommodate structural changes in input data, and recalibrating postprocessing thresholds to maintain output stability.

The present disclosure is advantageous in that by implementing end-to-end automation, it reduces manual intervention and errors across all model types. By leveraging a structured verification process, the system ensures that only secure and compliant models are integrated, mitigating risks related to tampered or non-compliant machine learning models. The automated feature extraction and mapping capabilities eliminate the need for manual data wrangling, significantly reducing deployment time and ensuring consistency in data transformation. Additionally, the intelligent identification and generation of missing features enhance compatibility between external models and target environments, allowing seamless integration even when feature discrepancies exist. The execution module ensures efficient model deployment without requiring extensive reconfiguration, while the output module improves result reliability by applying domain-specific validation, anomaly detection, and root cause analysis. The system's ability to dynamically adapt through synonym dictionaries, inference-based feature generation, and LLM-powered compliance checks makes it highly scalable and adaptable across different industries and machine learning use cases.

Further, the present disclosure is also technically advanced in that it provides multi-layered model security verification with both cryptographic validation and LLM-driven documentation compliance checking. The cryptographic validation ensures that the external machine learning model has not been tampered with by comparing its calculated checksum against an expected checksum extracted from the model documentation 102. Simultaneously, the LLM-driven compliance analysis examines the model documentation 102 for inconsistencies, malicious content, and quality issues, adding an additional layer of security beyond traditional cryptographic methods.

The present disclosure is significantly advantageous in that it offers a three-layer hybrid postprocessing approach by integrating statistical methods, documentation guidelines, and LLM-driven reasoning to ensure reliable and contextually accurate output refinement.

The system applies historical statistics and predefined domain thresholds to detect outlier predictions or unexpected variations in model outputs. This ensures that results remain within an expected range based on past data distributions, reducing the risk of erroneous decisions caused by model drift, biased training data, or corrupted inputs.

The system cross-references model outputs against domain-specific guidelines extracted from the model documentation. This enforces business logic, regulatory constraints, or operational rules, ensuring that model predictions adhere to predefined expectations. For example, if the model predicts a high-risk classification for a loan applicant with a perfect credit score, the system flags the inconsistency based on financial institution policies outlined in the model documentation.

Instead of merely flagging or correcting anomalies, the system employs an LLM-powered reasoning engine to analyze input features, historical outputs, and contextual information to determine why a certain output appears incorrect or unexpected. By identifying the root causes such as incorrect feature mappings, missing contextual information, or shifts in input distributions the system provides actionable insights to improve data quality and model performance.

The present disclosure dramatically reduces the manual effort and error margins associated with the current BYOM process by fully automating model registration, feature mapping, and output validation for any type of machine learning model. Traditional BYOM workflows require extensive manual intervention, from verifying model integrity and defining feature mappings to deploying inference pipelines and validating outputs. The present disclosure eliminates these complexities through intelligent automation, reducing human dependency, misconfigurations, and operational bottlenecks.

Those skilled in the art will realize that the above-recognized advantages and other advantages described herein are merely exemplary and are not meant to be a complete rendering of all of the advantages of the various embodiments of the present disclosure.

In the foregoing complete specification, specific embodiments of the present disclosure have been described. However, one of the ordinary skill in the art appreciates that various modifications and changes can be made without departing from the scope of the present disclosure. Accordingly, the specification and figures are to be regarded in an illustrative rather than a restrictive sense. All such modifications are intended to be included within the scope of the present disclosure.

What is claimed is:

1. A system for automatically integrating an external machine learning model into a target computing environment, the system comprising:
a processor;
a memory storing instructions that, when executed by the processor, configure the processor to:
verify integrity of an external machine learning model based on associated model documentation;
extract feature requirements from the model documentation using natural language processing;
map features required by the external machine learning model to available data in the target computing environment using a multi-tiered mapping strategy;
identify missing features through comparison of model requirements and available data;
generate executable code to create the identified missing features based on the model documentation;
execute the external machine learning model using the mapped and created features; and
process outputs from the external machine learning model using a multi-layer approach.

2. The system of claim 1, wherein verifying integrity of the external machine learning model comprises a dual-layer security verification including cryptographic validation and documentation compliance analysis.

3. The system of claim 2, wherein the cryptographic validation comprises:
extracting an expected checksum from the model documentation; and
comparing the expected checksum with a calculated checksum of the external machine learning model.

4. The system of claim 2, wherein the documentation compliance analysis detects malicious content and quality issues using a language learning model.

5. The system of claim 1, wherein the system is further configured to generate synonym dictionaries for the extracted feature requirements to bridge terminology differences between the model documentation and the target computing environment.

6. The system of claim 5, wherein generating synonym dictionaries comprises using a language learning model to generate comprehensive synonyms based on domain-specific terminology.

7. The system of claim 1, wherein the multi-tiered mapping strategy comprises direct matching, case-insensitive matching, synonym-based matching and language model-assisted mapping.

8. The system of claim 1, wherein the system is further configured to dynamically generate synonym dictionaries in real time for resolving domain-specific naming inconsistencies during the multi-tiered mapping process.

9. The system of claim 1, wherein identifying missing features comprises performing a comprehensive comparison between the model requirements extracted from the model documentation and available data in the target computing environment.

10. The system of claim 1, wherein the system is further configured to validate features against sample payloads with data type verification.

11. The system of claim 1, wherein generating executable code comprises inferring calculation methods from feature names without pre-defined rules.

12. The system of claim 11 further comprises inferring complex time-based and lag transformations from metadata of the model documentation, and generating executable code with a fallback logic for a given machine learning model type.

13. The system of claim 10, wherein generating executable code further comprises implementing fallback mechanisms when inference is unsuccessful.

14. The system of claim 1, wherein the multi-layer approach for processing outputs comprises:
statistical anomaly detection comparing recent output values to historical means and standard deviations,
application of domain-specific thresholds and best practices extracted from the model documentation; and
context-based root cause analysis performed by a language learning model, referencing both input features and historical context.

15. The system of claim 12, wherein the system provides detailed explanations for corrections made during output processing.

16. The system of claim 1, wherein the system is further configured to automatically construct a semantic data frame by parsing the model documentation, and map extracted textual feature descriptions to structured data representations to facilitate data matching and validation.

17. A computer-implemented method for automatically integrating an external machine learning model into a target computing environment, the method is configured to:
verify integrity of an external machine learning model based on associated model documentation;
extract feature requirements from the model documentation using natural language processing;
map features required by the external machine learning model to available data in the target computing environment using a multi-tiered mapping strategy;
identify missing features through comparison of model requirements and available data;
generate executable code to create the identified missing features based on the model documentation;
execute the external machine learning model using the mapped and created features; and
process outputs from the external machine learning model using a multi-layer approach.

18. The computer-implemented method of claim 17, wherein verifying integrity of the external machine learning model comprises a dual-layer security verification including cryptographic validation and documentation compliance analysis.

19. The computer-implemented method of claim 18, wherein the cryptographic validation comprises:
extracting an expected checksum from the model documentation; and
comparing the expected checksum with a calculated checksum of the external machine learning model.

20. The computer-implemented method of claim 18, wherein the model documentation compliance analysis detects malicious content and quality issues using a language learning model.

21. The computer-implemented method of claim 17, wherein the system is further configured to generate synonym dictionaries for the extracted feature requirements to bridge terminology differences between the model documentation and the target computing environment.

22. The computer-implemented method of claim 17, wherein generating synonym dictionaries comprises using a language learning model to generate comprehensive synonyms based on domain-specific terminology.

23. The computer-implemented method of claim 17, wherein the multi-tiered mapping strategy comprises direct matching, case-insensitive matching, synonym-based matching and language model-assisted mapping.

24. The computer-implemented method of claim 17, wherein identifying missing features comprises performing a comprehensive comparison between model requirements extracted from the model documentation and available data in the target computing environment.

25. The computer-implemented method of claim 17, wherein generating executable code comprises inferring calculation methods from feature names without pre-defined rules.

26. The computer-implemented method of claim 25, wherein generating executable code further comprises implementing fallback mechanisms when inference is unsuccessful.

27. The computer-implemented method of claim 17, wherein the multi-layer approach for processing outputs comprises:
statistical anomaly detection using historical statistics and domain thresholds;
application of domain-specific guidelines extracted from the model documentation; and
language model-based root cause analysis considering input features and historical context.

28. The computer-implemented method of claim 17 further comprises automatically constructing a semantic data frame by parsing the model documentation, and map extracted textual feature descriptions to structured data representations to facilitate data matching and validation.
